(19) United States
(12) Patent Application Publication
(10) Pub. No.: US 2026/0056982 A1
(43) Pub. Date: Feb. 26, 2026

(54) METHOD AND SYSTEM FOR DYNAMICALLY GENERATING ARTIFICIAL INTELLIGENCE-BASED ANSWER IN WHICH MESSAGE OF INFORMATION PROVIDER IS PROJECTED

(71) Applicant: NAVER CORPORATION, Seongnam-si (KR)

(72) Inventors: Min Kyeam KIM, Seongnam-si (KR); Jae Min AHN, Seongnam-si (KR); Seok Won PARK, Seongnam-si (KR); Sungeun KIM, Seongnam-si (KR); Sun Young HA, Seongnam-si (KR); Jisu SEO, Seongnam-si (KR); Jaeman PARK, Seongnam-si (KR); Sae Rom PARK, Seongnam-si (KR); Jinseok LIM, Seongnam-si (KR)

(21) Appl. No.: 19/375,528

(22) Filed: Oct. 31, 2025

Related U.S. Application Data
(63) Continuation of application No. PCT/KR2024/011973, filed on Aug. 12, 2024.

(30) Foreign Application Priority Data
Aug. 23, 2023 (KR) 10-2023-0110460

(51) Int. Cl. G06F 16/332; G06F 16/338

(52) U.S. Cl. CPC G06F 16/3326; G06F 16/338

(57) ABSTRACT

A method for dynamically generating an artificial intelligence-based answer including a message of an information provider includes selecting a first information provider from among a plurality of information providers on the basis of a large language model (LLM) result generated based on an LLM with respect to a user's prompt; dynamically generating an answer reflecting information registered in association with the selected first information provider; and providing the generated answer.

### CROSS-REFERENCE TO RELATED APPLICATIONS

This application is a continuation of International Application No. PCT/KR2024/011973, filed Aug. 12, 2024, which claims the benefit of Korean Patent Application No. 10-2023-0110460, filed Aug. 23, 2023.

### BACKGROUND OF THE INVENTION

### Field of the Invention

The present invention relates to a method and a system for dynamically generating an artificial intelligence (AI)-based answer in which a message of an information provider is included.

### Description of Related Art

A large language model (LLM) is a type of artificial intelligence trained on large corpora of text data to generate a human-like responses to a natural language input, and a language model configured with an artificial neural network having a large number of parameters (typically billions of weights or more). Such an LLM may be trained on a significant amount of unlabeled text using self-supervised or semi-self-supervised learning.

### BRIEF SUMMARY OF THE INVENTION

Example embodiments of the present invention provide a method and a system that dynamically generate an artificial intelligence-based answer in which a message of an information provider is included.

According to an example embodiment, there is provided an answer generation method of a computer device including at least one processor, the answer generation method including selecting, by the at least one processor, a first information provider from among a plurality of information providers based on large language model (LLM) results that are generated based on an LLM with respect to a prompt of a user; dynamically generating, by the at least one processor, an answer that reflects information registered in association with the selected first information provider; and providing, by the at least one processor, the generated answer.

According to an aspect, the selecting of the first information provider may include initially selecting, from among the plurality of information providers, information providers related to at least one of the prompt of the user, the LLM results, and a recommendation query generated by the LLM; and selecting the first information provider by dynamically conducting an auction among the initially selected information providers.

According to another aspect, the dynamically generating of the answer may include dynamically generating the answer using at least one of an asset registered by the first information provider and a prompt registered by the first information provider.

According to still another aspect, the asset may include at least one of a uniform resource locator (URL) related to content the first information provider desires to provide, a title of the content, an identifier of the content, a category of the content, multimedia related to the content, and contents of an article related to the content.

According to still another aspect, the prompt registered by the first information provider may include at least one of a phrase or a keyword that is input to emphasize in association with the content the first information provider desires to provide and a tone or a format of an information message to be provided as the answer.

According to still another aspect, the dynamically generating of the answer may include generating the answer by further reflecting at least one of the prompt of the user and the LLM results.

According to still another aspect, the dynamically generating of the answer may include generating the answer by further reflecting information on the user, and information on the user may include at least one of the user's demographics, interests, and purchase information.

According to still another aspect, the prompt of the user may be input through a search service, and the dynamically generated answer may be included in search results for the prompt of the user and provided to the user through the search service.

According to still another aspect, the search results may further include the LLM results.

According to still another aspect, the prompt of the user may be input through a conversation between artificial intelligence and the user using the LLM, and the dynamically generated answer may be included in answer results for the prompt of the user and provided to the user.

According to still another aspect, the answer generation method may further include generating, by the at least one processor, a question to elicit additional information for selection of the first information provider; and providing, by the at least one processor, the generated question.

According to an example embodiment, there is provided a computer program stored in a computer-readable recording medium to execute the answer generation method on a computer device.

According to an example embodiment, there is provided a computer-readable recording medium storing a program to execute the answer generation method on a computer device.

According to an example embodiment, there is provided a computer device including at least one processor configured to execute computer-readable instructions, wherein the at least one processor causes the computer device to select a first information provider from among a plurality of information providers based on large language model (LLM) results that are generated based on an LLM with respect to a prompt of a user, to dynamically generate an answer that reflects information registered in association with the selected first information provider, and to provide the generated answer.

According to example embodiments, a method and a system dynamically generate an artificial intelligence-based answer in which a message of an information provider is included.

### BRIEF DESCRIPTION OF THE DRAWINGS

FIG. 1 is a diagram illustrating a network environment according to an example embodiment.

FIG. 2 is a block diagram illustrating a computer device according to an example embodiment.

FIG. 3 is a diagram illustrating an answer generation system according to an example embodiment.

FIG. 4 is a flowchart illustrating an answer generation method according to an example embodiment.

FIG. 5 is a flowchart illustrating a process of supplementing a prompt of a user according to an example embodiment.

FIG. 6 is a diagram describing a process of providing an answer to a prompt of a user according to an example embodiment.

FIG. 7 is a diagram illustrating a manner of providing search results according to an example embodiment.

### DETAILED DESCRIPTION OF THE INVENTION

Hereinafter, example embodiments will be described in detail with reference to the accompanying drawings.

An answer generation system according to the example embodiments may be implemented by at least one computer device. Here, a computer program according to an example embodiment may be installed and executed on the computer device that implements the answer generation system, and the computer device may perform an answer generation method according to the example embodiments under the control of the executed computer program. The aforementioned computer program may be stored in a computer-readable storage medium to computer-implement the answer generation method in conjunction with the computer device.

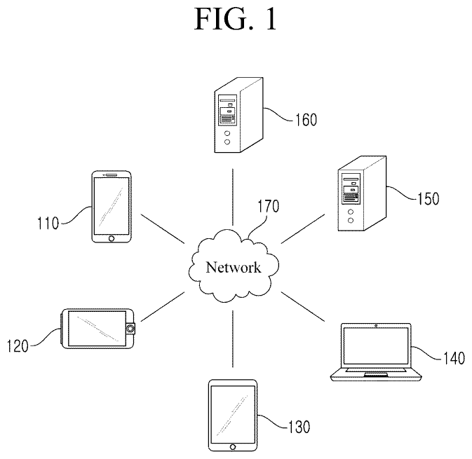

FIG. 1 illustrates an example of a network environment according to an example embodiment. Referring to FIG. 1, the network environment may include a plurality of electronic devices 110, 120, 130, 140, a plurality of servers 150, 160, and a network 170. FIG. 1 is provided as an example only. The number of electronic devices or the number of servers is not limited thereto.

Each of the plurality of electronic devices 110, 120, 130, 140 may be a fixed terminal or a mobile terminal that is configured as a computer system. For example, the plurality of electronic devices 110, 120, 130, 140 may be a smartphone, a mobile phone, a navigation device, a computer, a laptop computer, a digital broadcasting terminal, a personal digital assistant (PDA), a portable multimedia player (PMP), a tablet personal computer (PC), a game console, a wearable device, an Internet of things (IoT) device, a virtual reality (VR) device, an augmented reality (AR) device, and the like. For example, although FIG. 1 illustrates a shape of a smartphone as an example of the electronic device 110, the electronic device 110 used herein may refer to one of various types of physical computer systems capable of communicating with other electronic devices 120, 130, 140 and/or the servers 150, 160 over the network 170 in a wireless or wired communication manner.

The communication scheme is not limited and may include a near field wireless communication scheme between devices as well as a communication scheme using a communication network (e.g., mobile communication network, wired Internet, wireless Internet, broadcasting network, and satellite network) includable in the network 170. For example, the network 170 may include at least one network among networks that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150, 160 may be implemented as a computer device or a plurality of computer devices that provides an instruction, a code, a file, content, a service, etc., through communication with the plurality of electronic devices 110, 120, 130, 140 over the network 170. For example, the server 150 may be a system that provides a first service to the plurality of electronic devices 110, 120, 130, 140 connected through the network 170, and the server 160 may be a system that provides a second service to the plurality of electronic devices 110, 120, 130, 140 connected through the network 170. In more detail, for example, the server 150 may provide a service (e.g., search service) desired by the corresponding application to the plurality of electronic devices 110, 120, 130, 140 as the first service through the application as a computer program that is installed and executed on the plurality of electronic devices 110, 120, 130, 140. As another example, the server 160 may provide a service that distributes a file for installing and executing the application to the plurality of electronic devices 110, 120, 130, 140 as a second service.

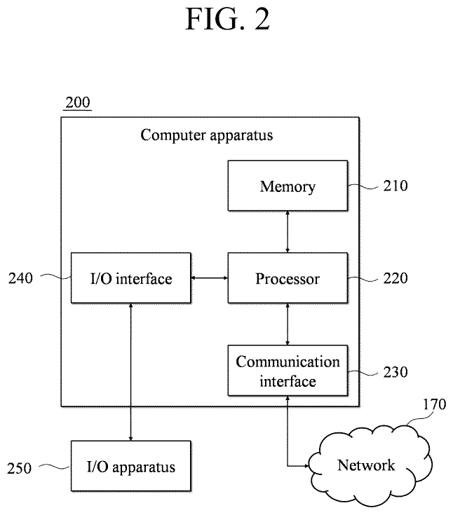

FIG. 2 is a block diagram illustrating an example of a computer device 200 according to an example embodiment. Each of the plurality of electronic devices 110, 120, 130, 140 or each of the servers 150, 160 described above may be implemented by the computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a computer-readable recording medium. A permanent mass storage device, such as ROM and a disk drive, may be included in the computer device 200 separate from the memory 210. Also, an operating system (OS) and at least one program code may be stored in the memory 210. Such software components may be loaded to the memory 210 from another computer-readable recording medium separate from the memory 210. The other computer-readable recording medium may include a computer-readable recording medium, for example, a floppy drive, a disk, a tape, a DVD/CD-ROM drive, a memory card, etc. According to other example embodiments, software components may be loaded to the memory 210 through the communication interface 230, instead of the computer-readable recording medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The instructions may be provided from the memory 210 or the communication interface 230 to the processor 220. For example, the processor 220 may be configured to execute received instructions in response to the program code stored in the storage device, such as the memory 210.

The communication interface 230 may provide a function for communication between the computer device 200 and another apparatus (e.g., the aforementioned storage devices) over the network 170. For example, the processor 220 of the computer device 200 may deliver a request or an instruction created based on a program code stored in the storage device such as the memory 210, data, and a file, to other apparatuses over the network 170 under the control of the communication interface 230. Inversely, a signal, an instruction, data, a file, etc., from another apparatus may be received at the computer device 200 through the network 170 and the communication interface 230 of the computer device 200. A signal, an instruction, data, etc., received through the communication interface 230 may be delivered to the processor 220 or the memory 210, and a file, etc., may be stored in a storage medium (e.g., the permanent storage device) further includable in the computer device 200.

The I/O interface 240 may be a device used for interfacing with an I/O device 250. For example, an input device of the I/O device 250 may include a microphone, a keyboard, a mouse, etc., and an output device of the I/O device 250 may include a display, a speaker, etc. As another example, the I/O interface 240 may be a device for interfacing with an apparatus in which an input function and an output function are integrated into a single function, such as a touchscreen. The I/O device 250 may be configured as a single apparatus with the computer device 200.

Also, in other example embodiments, the computer device 200 may include greater or less number of components than those shown in FIG. 2. For example, the computer device 200 may include at least a portion of the I/O device 250, or may further include other components, for example, a transceiver, a database, etc.

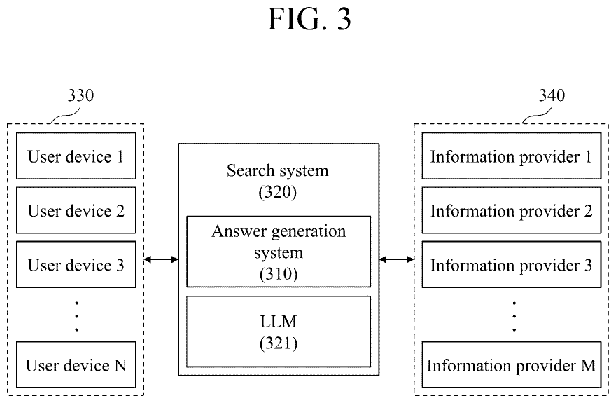

FIG. 3 is a diagram illustrating an example of an answer generation system according to an example embodiment. FIG. 3 illustrates an answer generation system 310, a search system 320, a plurality of user devices 330, and a plurality of information providers 340.

The search system 320 may correspond to a server (e.g., server 150) that provides a search service to the plurality of user devices 330, and may be implemented as at least one computer device 200. Here, each of the plurality of user devices 330 may be a physical device of a user that connects to the search system 320 using the network 170 to be provided with the search service, and this physical device may be the aforementioned electronic devices 110, 120, 130, 140 implemented in the computer device 200.

The answer generation system 310 according to an example embodiment may be implemented to be included in the search system 320, or to interwork with the search system 320 through the network 170. The embodiment of FIG. 3 represents an example in which the answer generation system 310 is included in the search system 320. In this case, the answer generation system 310 may be implemented on at least one physical device to implement the search system 320. Depending on example embodiments, the answer generation system 310 may also be implemented as a separate physical device implemented in at least one computer device from the physical device that implements the search system 320, and may be implemented to communicate with the search system 320 over the network 170.

The search service provided by the search system 320 to the plurality of user devices 330 may include search results corresponding to user input. The search results may be generated based on information searchable on the web. Also, the search system 320 may provide the search service by including information provided by the plurality of information providers 340 in the search results. Here, information provided by the plurality of information providers 340 may be, but not limited to, advertising information. The search service itself that provides the search results is already well known, so detailed description thereof is omitted.

The search system 320 according to the example embodiment may provide the search service by including, in the search results, answers based on artificial intelligence such as a large language model (LLM) 321. For example, the search system 320 may receive a natural language-based prompt from a specific user among the plurality of user devices 330. In this case, the search system 320 may input the received prompt into the LLM 321, may generate a first answer suitable for the prompt as LLM results, and may provide the search results including the first answer to the user. Here, the search results may include at least a portion of the existing various search results in addition to the first answer. Also, the search system 320 may also provide a search service through a conversation between LLM-based artificial intelligence and the user. A first mode that provides the first answer as the LLM results through a typical search service and a second mode that provides the first answer as the LLM results through a conversation between LLM-based artificial intelligence and the user may provide the search service to the user by switching between the first mode and the second mode. Here, in each of the first mode and the second mode, at least a portion of the first answer may further provide an instance for content of an information provider as a second answer. In this embodiment, although the search system 320 includes the LLM 321, in other embodiments, the search system 320 may integrate an externally provided LLM into its own application based on API access.

Depending on example embodiments, the search system 320 may verify whether the natural language-based prompt received from the user is a user prompt that may provide information relating to an information provider 340. For example, an advertiser may not desire its advertisement to be exposed to a prompt that requests preset illegal information or preset non-advertising information. Therefore, the search system 320 may first verify whether it is safe to provide information relating to the information provider 340 in response to a user prompt. Here, if the user prompt does not requests preset illegal information or preset non-advertising information, the search system 320 may request the answer generation system 310 to generate and provide the second answer.

The answer generation system 310 may dynamically generate an artificial intelligence-based second answer that projects a message of an information provider selected from among the plurality of information providers 340. In this case, the search system 320 may provide the user with the search results that include not only the first answer generated using the LLM, but also the artificial intelligence-based second answer generated by the answer generation system 310.

Here, when generating the artificial intelligence-based second answer, the answer generation system 310 does not simply provide information provided by the information provider 340 as is, and may dynamically generate the artificial intelligence-based second answer using the user prompt, the first answer generated using the LLM, the asset registered by the information provider 340, and/or the prompt registered by the information provider 340. The dynamic generation of the second response may not simply mean utilizing the information provided by the information provider as-is, but rather may mean generating and utilizing the information provider's data in the form of a dynamically generated response created through artificial intelligence, reflecting the information provider's data.

Here, the asset may include a uniform resource locator (URL) related to content the information provider 340 desires to provide, a title or an identifier of the content, a category of the content, multimedia related to the content, and contents of an article related to the content. Here, the multimedia related to the content may include an image and a video related to the content. For example, when the information provider is advertising a specific product or service, the asset may include a URL related to the product or the service, a product name or a service name, a category of the product or the service, product information or service information, articles related to the product or the service. Also, the prompt registered by the information provider may include information on a phrase or a keyword desired to emphasize in relation to content the information provider 340 desires to provide, a tone or a format of an information message to be provided as the second answer. In this way, the answer generation system 310 may dynamically generate the second answer in consideration of not only the first answer generated using the LLM 321 for the natural-language-based prompt of the user but also the asset and the prompt registered by the information provider 340 that desires to provide information of the information provider.

Also, depending on example embodiments, the answer generation system 310 may also generate the second answer by further using information regarding the user. Here, information regarding the user may include the user's demographics, interests, and purchase information, and may be used to customize the second answer to the user.

In addition, since there may be a plurality of information providers 340 that desire to expose their information, the answer generation system 310 may dynamically determine which information provider's asset and prompt among the plurality of information providers may be used to generate the second answer. For example, the answer generation system 310 may initially select information providers 340 related to the first answer, that is, the LLM results based on the first answer from among the plurality of information providers. Depending on example embodiments, the answer generation system 310 may use at least one of the user prompt, the LLM results, and a recommendation query generated by the LLM 321 in terms of initially selecting the information providers 340. Then, the answer generation system 310 may dynamically conduct an auction among the initially selected information providers 340, and may select a first information provider as an information provider for generating the second answer. A method of the auction may employ one of well-known methods. For example, a generalized second price (GSP) auction method may be used.

As such, when the search system 320 provides an answer to the natural language-based prompt from the user, the answer generation system 310 may dynamically generate an answer based on the asset and the prompt of the information provider 340, that is, the artificial intelligence-based second answer that projects a message of the information provider. Therefore, the search system 320 may provide the dynamically generated answer to the user such that the message of the information provider 340 is projected in relation to the natural language-based prompt received from the user.

Also, depending on example embodiments, the contents of the user prompt may be insufficient to match with a specific information provider 340. In this case, the answer generation system 310 may provide the user with a question through the search system 320 to induce the user to include sufficient information in the user prompt for the matching. Information acquired through the answer of the user to the question may also be included in the user prompt.

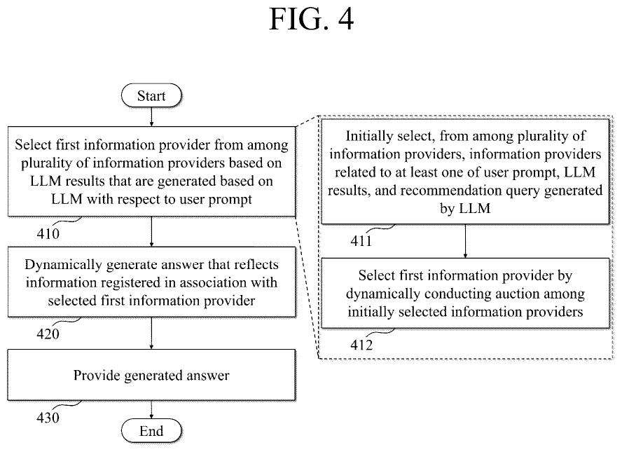

FIG. 4 is a flowchart illustrating an example of an answer generation method according to an example embodiment. The answer generation method according to the example embodiment may be performed by the computer device 200 that implements the aforementioned answer generation system 310. Here, the processor 220 of the computer device 200 may be implemented to execute a control instruction according to a code of at least one computer program or a code of an operating system included in the memory 210. Here, the processor 220 may control the computer device 200 to perform operations 410 to 430 included in the method of FIG. 4 in response to a control instruction provided from a code stored in the computer device 200.

In operation 410, the computer device 200 may select a first information provider from among a plurality of information providers based on LLM results that are generated based on an LLM with respect to a user prompt. The plurality of information providers may correspond to the plurality of information providers 340 described above with reference to FIG. 3. For example, the LLM results may be generated by the aforementioned search system 320. In this case, the computer device 200 may select the first information provider based on the generated LLM results. This may be a process of selecting the first information provider that provides information related to the LLM results. Depending on example embodiments, operation 410 may include operations 411 and 412.

In operation 411, the computer device 200 may initially select, from among the plurality of information providers, information providers related to at least one of the user prompt, the LLM results, and a recommendation query generated by the LLM. As described above, the initially selected information providers may include information providers that desire to provide information related to at least one of the user prompt, the LLM results, and the recommendation query. For example, the computer device 200 may compare at least one of the user prompt, the LLM results, and the recommendation query with each piece of information registered in association with the plurality of information providers, and may initially select information providers that register information related to at least one of the user prompt, the LLM results, and the recommendation query.

In operation 412, the computer device 200 may select the first information provider by dynamically conducting an auction among the initially selected information providers. For example, the computer device 200 may select the first information provider by conducting a dynamic auction among the initially selected information providers using a well-known auction method, such as a GSP auction method.

In operation 420, the computer device 200 may dynamically generate an answer that reflects information registered in association with the selected first information provider. For example, the computer device 200 may dynamically generate an answer using at least one of an asset registered by the first information provider and a prompt registered by the first information provider. Here, the asset may include at least one of a URL related to content the first information provider desires to provide, a title of the content, an identifier of the content, a category of the content, multimedia related to the content, and contents of an article related to the content. Also, the prompt registered by the first information provider may include at least one of a phrase or a keyword that is input to emphasize in association with the content the first information provider desires to provide and a tone or a format of an information message to be provided as the answer.

Depending on example embodiments, the computer device 200 may generate the answer by further reflecting the user prompt and/or the LLM results. That is, the computer device 200 may generate the answer by reflecting at least one of the user prompt and the LLM results generated based on the LLM with respect to the user prompt, and information registered in association with the selected first information provider.

In another example embodiment, the computer device 200 may generate the answer by further reflecting information regarding the user. Here, information regarding the user may include at least one of the user's demographics, interests, and purchase information. That is, the computer device 200 may generate the answer by reflecting all of information registered in association with the first information provider 340 and information regarding the user.

In another example embodiment, the computer device 200 may generate the answer by reflecting at least one of the user prompt and the LLM results generated based on the LLM with respect to the user prompt, information registered in association with the first information provider, and information on the user.

In operation 430, the computer device 200 may provide the generated answer. For example, the user prompt may be input through the search service provided by the search system 320. In this case, the search system 320 may generate the LLM results for the user prompt and may verify the user prompt. When it is determined that the user prompt is not a prompt that requests preset illegal information or preset non-advertising information, the search system 320 may transmit the LLM results to the answer generation system 310 and may request generation of the answer. The computer device 200 may generate the answer through operations 410 and 420 and may provide the generated answer to the search system 320 in operation 430. In this case, the search system 320 may generate the search results including the answer generated by the answer generation system 310 and the LLM results and may provide the generated search results to the user. Here, the search results may further include the search results based on an existing search term.

Depending on example embodiments, the user prompt may be input through a conversation between the artificial intelligence and the user using the LLM. In this case, the dynamically generated answer may be included in the answer results (answer of artificial intelligence in conversation between user and artificial intelligence) for the user prompt and may be provided to the user.

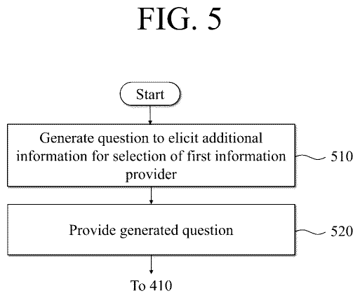

FIG. 5 is a flowchart illustrating a process of supplementing a prompt of a user according to an example embodiment. Depending on example embodiments, the answer generation system 310 may also perform operations 510 and 520 to supplement the user prompt before operation 410 of FIG. 4.

In operation 510, the computer device 200 may generate a question to elicit additional information for selection of the first information provider. As described above, contents of the user prompt may be insufficient to match information of a specific information provider. In this case, the computer device 200 may generate a question to induce the user to include sufficient information in the user prompt for matching between the user prompt and information of the information provider. This question may also be generated based on the LLM.

In operation 520, the computer device 200 may provide the generated question. For example, the generated question may be provided to the user through the search service of the search system 320. When the user enters an answer to the provided question, the answer of the user may be included in the user prompt and the contents of the user prompt may be supplemented. Generation and provision of this question may be iteratively performed until the contents of the user prompt satisfy matching with information of the specific information provider. Information providers of which registered information matches the contents of the user prompt may correspond to the initially selected information providers, and as described above, the first information provider may be selected in operation 410 through the auction among the initially selected information providers.

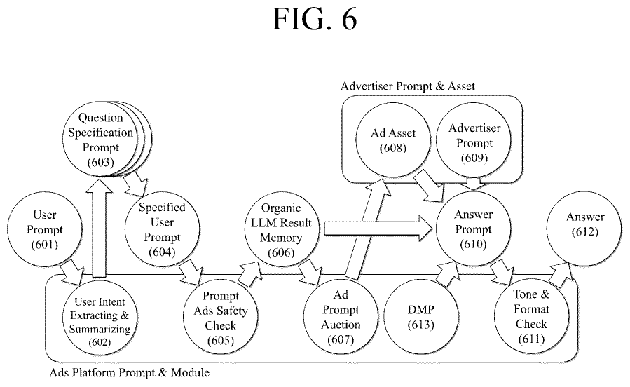

FIG. 6 illustrates a process of providing an answer to a prompt of a user according to an example embodiment. The embodiment of FIG. 6 describes an example of a case in which information providers desire to display advertisements for products or services of advertisers as information.

The search system 320 may receive a user prompt 601 from a terminal of a user, which is one of the plurality of user devices 330, connected through the network 170. For example, a prompt may correspond to a natural language-based search term that is input from the user. The user may input the search term through a user interface of a search service provided through the terminal of the user, and the search system 320 may receive the search term input through the user interface as the user prompt 601.

Here, the search system 320 may analyze the user prompt 601 through a process of user intent extracting and summarizing 602 to extract and summarize the user intent, thereby selecting a prompt to be used.

The search system 320 and/or the answer generation system 310 may induce the user to provide sufficient information for provision of an answer that reflects a marketing message of an advertiser. For example, the contents of the user prompt 601 may be insufficient to match the marketing message of a specific advertiser. In this case, the answer generation system 310 may generate a question to elicit additional information for selection of a specific advertiser, and may provide the generated question to the user through the search system 320. If the user's answer to the question is received, the prompt may be supplemented using the contents of the received answer. A question specification prompt 603 may include a prompt that is acquired through the answer of the user.

Here, the search system 320 and/or the answer generation system 310 may select a specified user prompt 604 as a prompt for provision of a marketing message. That is, the specified user prompt 604 may be specified based on the prompt acquired through the process of user intent extracting and summarizing 602 for the user prompt 601 and the question specification prompt 603.

Prompt ads safe check 605 may be an example of a process of verifying whether the specified user prompt 604 is a prompt acceptable for displaying the marketing message of the advertiser for the user. For example, when the specified user prompt 604 is not a prompt that requests preset illegal information or preset non-advertising information, the search system 320 may request the answer generation system 310 to generate and provide the answer.

Also, the search system 320 may generate LLM results by inputting the specified user prompt 604 to an LLM. FIG. 5 shows an example of an organic LLM result memory 606 that stores such LLM results.

The answer generation system 310 may initially select advertisers related to the LLM results based on the LLM results stored in the organic LLM result memory 606. Here, the advertisers related to the LLM results may be advertisers who have registered marketing messages that deserve to be displayed with the LLM results. A marketing message to be displayed along with the LLM results may be selected based on relevance between information registered by advertisers and the LLM results. Also, depending on example embodiments, when initially selecting the advertisers, the answer generation system 310 may use at least one of the user prompt 604, the LLM results, and the recommendation query generated by the LLM. In this case, the answer generation system 310 may initially select advertisers based on relevance between at least one of the user prompt 604, the LLM results, and the recommendation query and information registered by the advertisers. Here, the answer generation system 310 may select a specific advertiser from among the initially selected advertisers through an ad prompt auction 607.

When the advertiser is selected, the answer generation system 310 may acquire an ad asset 608 registered by the selected advertiser and an advertiser prompt 609 registered by the selected advertiser. In this case, the answer generation system 310 may generate an answer prompt 610 that reflects the marketing message of the advertiser using at least one of the user prompt 601 and the LLM results stored in the organic LLM result memory 606 and at least one of the ad asset 608 and the advertiser prompt 609. Depending on example embodiments, the advertiser may desire to provide an answer in a specific format according to the characteristics of the user. To this end, the answer generation system 310 may generate the answer prompt 610 by further reflecting information regarding the user. For example, information regarding the user may include at least one of the user's demographics, interests, and purchase information. For example, the answer generation system 310 may analyze the advertiser prompt 609 and may verify that the advertiser desires to provide a relatively more detailed answer to a female user than to a male user. In this case, the answer generation system 310 may verify the user's gender through the user's demographics and then may generate the answer prompt 610 by considering the verified user's gender.

When the answer prompt 610 is generated, the answer generation system 310 may verify whether the generated answer prompt 610 is suitable for the tone and/or format verified through the advertiser prompt 609 (611). If the generated answer prompt 610 does not match the tone and/or format desired by the advertiser, the answer prompt 610 may be processed to match the tone and/or format desired by the advertiser. Also, depending on example embodiments, the answer generation system 310 may additionally check whether the generated answer prompt 610 is appropriate to be displayed.

Then, the answer generation system 310 may provide a finally generated answer 612 to the user through the search system 320. For example, the search system 320 may add the answer 612 provided from the answer generation system 310 to the search results and may provide the same to the user through the search service. Also, depending on example embodiments, user information (e.g., gender, age, interests) stored in a data management platform (DMP) 613 may be further used to generate the answer prompt 610. By utilizing this user information, the answer generation system 310 may generate the answer 612 optimized for the user.

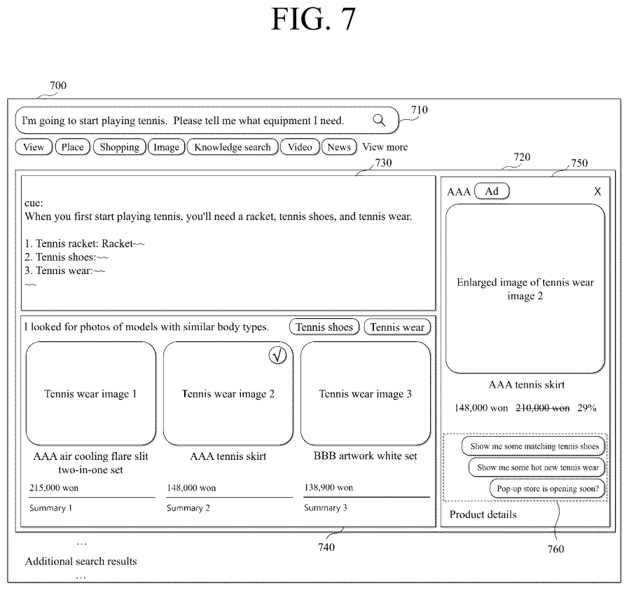

FIG. 7 illustrates an example of providing search results according to an example embodiment. FIG. 7 illustrates an example of a screen of a search page 700 provided to a user 330 through a search service. The search page 700 may include a user interface 710 for receiving a user prompt. Also, the search page 700 may include a search result area 720 for displaying search results. Here, the search result area 720 may include an LLM result area 730 for displaying the LLM results generated based on an LLM with respect to the user prompt.

Also, the search result area 720 represents an example of an answer area 740 for displaying an answer generated by the answer generation system 310 for the user prompt. The example embodiment represents an example in which a plurality of answers are displayed through the answer area 740. In this way, the plurality of answers may be generated and displayed for a single prompt. Also, answers may be generated and displayed for each of at least two information providers. To this end, the answer generation system 310 may select two or more information providers.

The embodiment of FIG. 7 represents an example in which an answer of an information provider 340 selected based on a user prompt input to the user interface 710 and/or the LLM results displayed in the LLM result area 730 is displayed through an extension area 750. For example, the answer of the information provider 340 selected based on at least one of the user prompt, the LLM results, and a recommendation query generated by the LLM may be further displayed through the extension area 750. If the information provider 340 is an advertiser, an advertisement of an advertiser selected based on at least one of the user prompt, the LLM results, and the recommendation query generated by the LLM may be further displayed through the extension area 750.

Also, a dotted box 760 displays questions for requesting an additional prompt from the user in relation to the answer displayed in the extension area 750. When the user selects a specific question, the question may be recognized as an additional prompt of the user. In the case of providing a conversational search service, the additional prompt of the user may be recognized as a subsequent conversation of the user. In this case, the search system 320 and/or the answer generation system 310 may generate the LLM results and/or answer in consideration of the entire conversation with the user.

Also, the embodiment of FIG. 7 describes an example of receiving a user prompt through the user interface 710 of the search service and dynamically generating an answer, but an interface for generating and providing a dynamic answer may be included in search results depending on example embodiments. For example, a function of receiving a user prompt and dynamically generating and providing an answer may be provided through each and/or some of various vertical services provided in an existing search ecosystem. Here, the vertical service may refer to a service for each of various collections that classify search results, such as shopping search, knowledge search, local search, user generated contents (UGC) search, language search, image search, video search, and news search. For example, in the case of providing a shopping search service as a vertical service of a separate integrated search service, a function for receiving a user prompt and generating and providing an answer through the shopping search service may be provided to the user. If a plurality of different advertising services are provided as the vertical service of the integrated search service, a function of dynamically receiving a user prompt and generating and providing an answer through each of the plurality of advertising services may be provided to the user.

As described above, according to example embodiments, a method and a system dynamically generate an artificial intelligence-based answer that reflects a message of an information provider.

The systems or the apparatuses described herein may be implemented using hardware components or combination of hardware components and software components. For example, the apparatuses and the components described herein may be implemented using one or more computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. A processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, instructions, or some combinations thereof, for independently or collectively instructing or configuring a processing device to operate as desired. Software and/or data may be embodied in any type of machine, component, physical equipment, virtual equipment, computer storage medium or device, to be interpreted by a processing device or to provide an instruction or data to the processing device. The software also may be distributed over network coupled computer systems so that the software is stored and executed in a distributed fashion. The software and data may be stored by one or more computer readable storage media.

The methods according to the above-described example embodiments may be configured in a form of program instructions that may be performed by various computer devices and recorded in computer-readable media. Computer-readable media may include, alone or in combination with program instructions, data files, data structures, and the like. The media may continuously store computer-executable programs or may transitorily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store program instructions, such as read-only memory (ROM), random access memory (RAM), flash memory, and the like. Examples of other media may include recording media and storage media managed by an app store that distributes applications or a site that supplies and distributes other various types of software, a server, and the like. Examples of program instructions include machine language code, such as those produced by a compiler, as well as high-level language code that may be executed by a computer using an interpreter and the like.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described methods are performed in different order, and/or if components in a described system, architecture, device, or circuit are combined in a different manner, or replaced or supplemented by other components or their equivalents.

Therefore, other implementations, other example embodiments, and equivalents of the claims are to be construed as being included in the claims.

What is claimed is:

1. An answer generation method executed by a computer device having at least one processor, the method comprising:
selecting, by the at least one processor, a first information provider from among a plurality of information providers based on large language model (LLM) results that are generated based on an LLM with respect to a prompt of a user;
dynamically generating, by the at least one processor, an answer that reflects information registered in association with the selected first information provider; and
providing, by the at least one processor, the generated answer to the user.

2. The answer generation method of claim 1, wherein the selecting of the first information provider comprises:
initially selecting, from among the plurality of information providers, information providers related to at least one of the prompt of the user, the LLM results, and a recommendation query generated by the LLM; and
selecting the first information provider by dynamically conducting an auction among the initially selected information providers.

3. The answer generation method of claim 1, wherein the answer is dynamically generated using at least one of an asset registered by the first information provider and a prompt registered by the first information provider.

4. The answer generation method of claim 3, wherein the asset includes at least one of a uniform resource locator (URL) related to content the first information provider desires to provide, a title of the content, an identifier of the content, a category of the content, multimedia related to the content, and contents of an article related to the content.

5. The answer generation method of claim 3, wherein the prompt registered by the first information provider includes at least one of a phrase or a keyword that is input to emphasize, in association with the content, a tone or a format of an information message to be provided as the answer.

6. The answer generation method of claim 1, wherein the answer is generated by further reflecting at least one of the prompt of the user and the LLM results.

7. The answer generation method of claim 1, wherein the answer is generated by further reflecting information regarding the user, and
the information regarding the user includes at least one of the user's demographics, interests, and purchase information.

8. The answer generation method of claim 1, wherein the prompt of the user is input through a search service, and
the dynamically generated answer is included in search results for the prompt of the user and provided to the user through the search service.

9. The answer generation method of claim 8, wherein the search results further include the LLM results.

10. The answer generation method of claim 1, wherein the prompt of the user is input through a conversation between artificial intelligence and the user using the LLM, and
the dynamically generated answer is included in answer results for the prompt of the user and provided to the user.

11. The answer generation method of claim 1, further comprising:
generating, by the at least one processor, a question to elicit additional information for selection of the first information provider; and
providing, by the at least one processor, the generated question to the user.

12. A non-transitory computer-readable recording medium storing a computer program that executes the method of claim 1 on a computer device.

13. A computer device comprising:
at least one processor configured to execute computer-readable instructions stored on a memory,
wherein the at least one processor is configured to execute the steps comprising:
selecting a first information provider from among a plurality of information providers based on large language model (LLM) results that are generated based on an LLM with respect to a prompt of a user,
dynamically generating an answer that reflects information registered in association with the selected first information provider, and
providing the generated answer to the user.

14. The computer device of claim 13, wherein the at least one processor selects the first information provider by,
initially selecting, from among the plurality of information providers, information providers related to at least one of the prompt of the user, the LLM results, and a recommendation query generated by the LLM, and
selecting the first information provider by dynamically conducting an auction among the initially selected information providers.

15. The computer device of claim 13, wherein the answer is dynamically generated using at least one of an asset registered by the first information provider and a prompt registered by the first information provider.

16. The computer device of claim 13, wherein the answer is dynamically generated by further reflecting at least one of the prompt of the user and the LLM results.

17. The computer device of claim 13, wherein the answer is dynamically generated by further reflecting information regarding the user, and
the information regarding the user includes at least one of the user's demographics, interests, and purchase information.
